(19) United States
(12) Patent Application Publication
(10) Pub. No.: US 2006/0231548 A1
(43) Pub. Date: Oct. 19, 2006

(54) Heating radiator

(75) Inventors: Cristiano Crosetta, Resana (IT); Renzo Crosetta, Resana (IT)

Correspondence Address: MODIANO & ASSOCIATI, Via Meravigli, 16, Milan, 20123, IT

(73) Assignee: TUBES RADIATORI - S.R.L.

(21) Appl. No.: 11/389,204

(22) Filed: Mar. 27, 2006

(30) Foreign Application Priority Data
Apr. 13, 2005 (IT) PD2005U000026

(51) Int. Cl. F28F 7/00; H05B 3/06

(52) U.S. Cl. 219/540; 165/80.4

(57) ABSTRACT

A heating radiator, comprising a substantially flat heating element, which is recessed within a jacket made of metal plate which is visible to the user of the radiator; the jacket is constituted by a front portion, from the side ends of which edge portions protrude which are folded so as to conceal the edge of the heating element. The heating element is in contact with the front portion and is comprised between the edge portions.

The present invention relates to a heating radiator.

### BACKGROUND OF THE INVENTION

As it is known, heating radiators and heaters in general have acquired important design aspects in recent years.

One market trend of furniture components for heating is to propose radiators which have a sparing style and are as flat as possible.

### SUMMARY OF THE INVENTION

The aim of the present invention is to provide a design-oriented heating radiator which has a particularly low thickness.

Within this aim, an object of the present invention is to provide a heating radiator which has a reduced edge thickness and at the same time allows to increase the heat radiation effect, thus improving the overall yield of the radiator with respect to known types of comparable radiator.

Another object of the present invention is to provide a heating radiator which is structurally simple and can be used with heating elements of various types without compromising its design particularities.

Another object of the present invention is to provide a heating radiator which can be manufactured with known systems and technologies.

This aim and these and other objects, which will become better apparent hereinafter, are achieved by a heating radiator, characterized in that it comprises a substantially flat heating element, which is recessed within a jacket made of metal plate which is visible to the radiator user, said jacket being constituted by a front portion, from the side ends of which edge portions protrude which are folded so as to conceal the edge of said heating element, said heating element being in contact with said front portion and being comprised between said edge portions.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a transverse sectional perspective view of a portion of a radiator according to the invention;

FIG. 2 is a transverse sectional view of a portion of a radiator according to the invention;

FIG. 3 is a transverse sectional view of a portion of a radiator according to a different embodiment with respect to the preceding figures;

FIG. 4 is a transverse sectional view of a portion of a radiator according to another embodiment with respect to the preceding figures;

FIG. 5 is a transverse sectional view of a portion of a radiator according to another embodiment with respect to the preceding figures;

FIG. 6 is a transverse sectional view of a portion of a radiator according to another embodiment with respect to the preceding figures.

### DESCRIPTION OF THE PREFERRED EMBODIMENTS

With reference to the figures, a first embodiment of a heating radiator according to the invention is generally designated by the reference numeral 10.

The radiator 10 comprises a heating element 11, which is of a substantially flat type, i.e. has a generally flat shape, and is embedded within a jacket 12, which is visible to the user of the radiator 10.

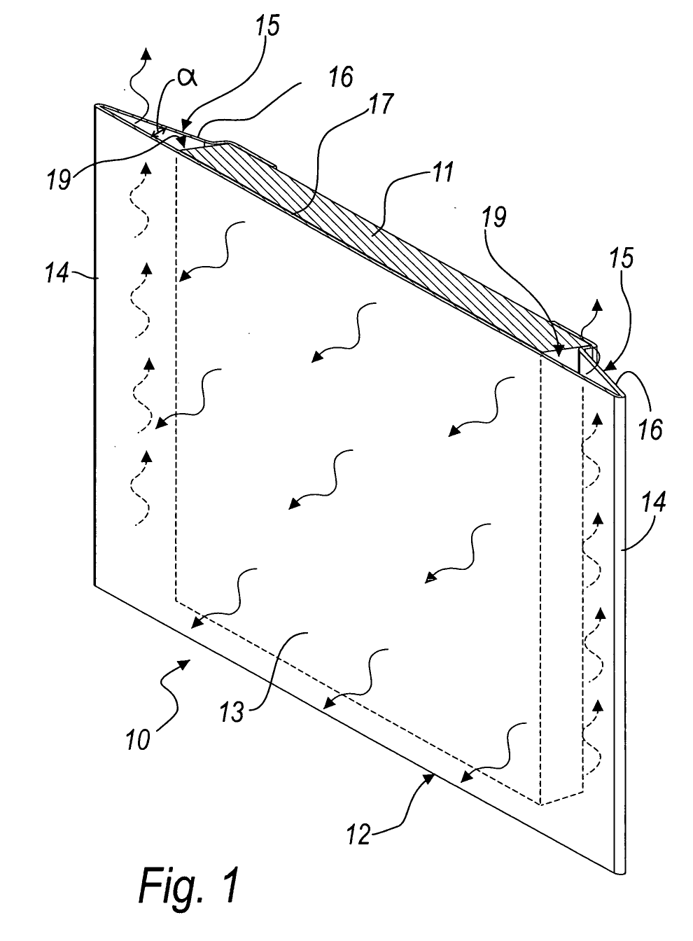

In FIG. 1, the heating element 11 is shown in cross-section for explanatory reasons as if it were a single block; in practice, the heating element 11 can be constituted for example by an electric plate, by a shell-and-tube element within which hot water or a specifically-provided liquid, such as for example glycol, flows, heated by electrical resistors inside the shell-and-tube structure, or by other equivalent heating elements.

The jacket 12 is constituted by a front portion 13, which is for example rectangular and from the side ends 14 of which edge portions 15 protrude.

The jacket 12 is made of metal plate, which is folded at its ends so as to form the edge portions 15.

The edge portions 15 taper outward.

The outer surfaces 16 of the edge portions 15 form, in this embodiment, an acute angle α with the internal surface 17 of the front portion 13.

In practice, the edge portions 15 and the front portion 13 delimit corner portions; the heating element 11 is comprised between said corner portions.

Advantageously, the corner portions and the side of the heating element 11 delimit respective vertical interspaces 19, which are arranged laterally with respect to the heating element 11.

Said heating element in practice is in contact with the front portion 13 and is comprised between the edge portions 15.

In particular, the structure thus described shows that the width of the heating element 11 is less than the distance between the lateral ends 14 of the front portion 13 and therefore less than the overall radiating surface.

The edge portions 15 also protrude from the lower and upper ends (not shown in the figures) of the front portion 13, so as to form in practice a continuous perimetric containment border for the heating element 11.

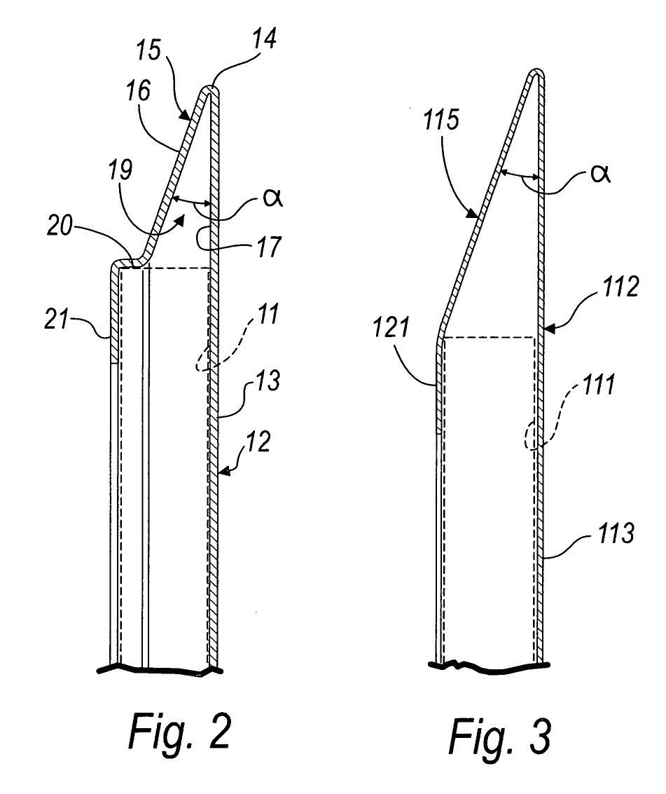

FIGS. 1 and 2 illustrate an example of a first embodiment of the jacket 12; the heating element 11 is shown in broken lines and the radiated heat is shown schematically by a plurality of wavy arrows.

In this embodiment, the edge portions 15 end with a bend 20 for the containment and abutment of the lateral end of the heating element 11 and have an end portion 21 which is parallel to the front portion 13 and is designed to lock in a sandwich-like fashion the heating element 11.

The bend 20 forms a discontinuity on the region of the edge portion 15 which is inclined by the angle α on the internal surface of the plate-like front portion 13.

FIG. 3 illustrates an example of an alternative embodiment of the jacket, designated generally by the reference numeral 112, in which the containment and abutment bend described earlier is not present; in this case also, the heating element 111 is shown in broken lines.

In this case, the edge portions 115 have an end region 121, which is simply folded with respect to the region of the edge portion 115 which is inclined by the angle α with respect to the internal surface of the front portion 113 and is parallel to the front portion 113 and adapted to lock in a sandwich-like fashion the heating element 111.

In this embodiment, lateral containment is provided by the region of the edge portion 115 which is inclined by the angle α with respect to the internal surface of the front portion 113.

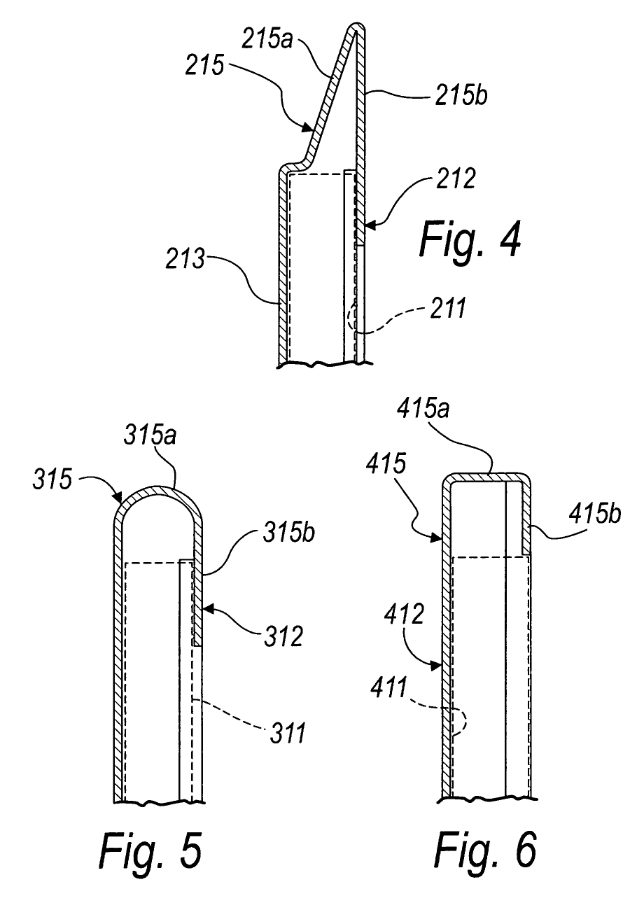

FIG. 4 illustrates another embodiment of the jacket, generally designated by the reference numeral 212; in this case also, the heating element 211 is shown in broken lines.

In this case, the edge portions 215 also taper outward; the edge portions 215 in fact have a first part 215a, which is inclined toward the wall to which the radiator is to be fixed, and a second tip part 215b, which is parallel to the front portion 213.

FIG. 5 illustrates another embodiment of the jacket, generally designated by the reference numeral 312; in this case also, the heating element 311 is shown in broken lines.

In this case, the edge portions 315 also taper outward; the edge portions 315 in practice are formed by a portion 315a, which is bent in the shape of a circular arc, and a portion 315b, which is parallel to the front portion 313.

FIG. 6 illustrates another embodiment of the jacket, generally designated by the reference numeral 412; in this case also, the heating element 411 is shown in broken lines.

In this case, the edge portions 415 are folded along a first region 415a, which is perpendicular to the front portion 413, and a second region 415b, which is perpendicular to the first portion 415a.

In practice it has been found that the invention thus described achieves the intended aim and objects.

The present invention in fact provides a radiator which is constituted by a flat heating element, which can be of various kinds and can have a low-quality aesthetic finish, and by a jacket, which covers said flat heating element and has a very low thickness.

Such jacket does not compromise the flat appearance of the radiator as a whole and at the same time conceals the heating element, which therefore can be produced without a high-quality finish and therefore at a lower cost than an externally-finished heating element.

Further, the jacket allows to protect the heating element against impact, particularly in the edge regions; in these regions, the deformation in fact affects only the interspace of the jacket and does not affect the heating element.

This avoids accidental damage to the heating element, which might cause the escape of any heat transfer fluid intended for heating.

Moreover, it is evident that for an equal total maximum thickness of the radiator, which in these embodiments is substantially equal to the thickness of the heating element, the thickness perceived by the person who uses said radiator is lower, since the edge portions taper outward, giving the effect of a slender, receding edge.

Moreover, a radiating surface has been provided which has a larger area than the radiating surface of a plate which is perfectly superimposed on the heating element.

The radiating surface of the front portion of the jacket which lies beyond the contact surface with the heating element is heated not only by conduction by the rest of the plate but also as an effect of the convection generated within the interspaces.

As a whole, therefore, the overall heat yield is higher than that of a plate which rests against a heating element of equal size.

Merely by way of example, some preferred dimensional ratios are given hereafter to highlight the “receding” edge effect provided by tapering the edge portions.

For example, the depth of the jacket 12 is comprised preferably substantially, i.e. to a large extent, between 6% and 8% of the height of said jacket, while the horizontal dimensions or extensions of the projections on said plate-like front portion 13 of the edge portions 15 are comprised substantially between 1% and 2% of the height of the jacket 12.

The acute angle α formed by the outer surfaces is preferably comprised for example substantially between 9° and 21°.

In practice, the materials employed, so long as they are compatible with the specific use, as well as the dimensions, may be any according to requirements and to the state of the art.

The disclosures in Italian Utility Model Application No. PD2005U000026 from which this application claims priority are incorporated herein by reference.

What is claimed is:

1. A heating radiator comprising: a jacket made of metal plate which is visible to a user of the radiator; and a flat heating element, which has an edge and is recessed within the jacket, said jacket being constituted by a front portion, with side ends from which edge portions protrude that are folded so as to conceal the edge of said heating element, said heating element being in contact with said front portion and being further comprised between said edge portions of said jacket.

2. The radiator of claim 1, wherein said heating element has a width which is less than a distance between said side ends of said front portion, said edge portions being folded so as to form an interspace with said front portion and the edge of said heating element.

3. The radiator of claim 2, wherein said edge portions are shaped so as to taper outward.

4. The radiator of claim 1, wherein said jacket is shaped with a depth extension that is comprised between 6% and 8% of a height extension thereof.

5. The radiator of claim 4, wherein projections on said front portion of said edge portions have horizontal extensions comprised between 1% and 2% of the height extension of said jacket.

6. The radiator of claim 5, wherein said edge portions are provided to also protrude from lower and upper ends of said front portion, so as to form a perimetric containment border for said heating element.

7. The radiator of claim 6, wherein said edge portions have external surfaces that form an acute angle α with an internal surface of said front portion.

8. The radiator of claim 7, wherein said acute angle α formed by the external surfaces of said edge portions with the internal surface of said front portion is comprised between 9° and 21°.

9. The radiator of claim 4, wherein said edge portions comprise an end bend for containment and abutment of the edge of said heating element, and have an end region which is parallel to said front portion for locking in a sandwich fashion said heating element.

10. The radiator of claim 7, wherein said edge portions have a tip portion, which is simply folded with respect to a region of the edge portion which is inclined by the angle α with respect to the internal surface of said front portion, is parallel to said front portion and is suitable to lock in a sandwich fashion said heating element.

11. The radiator of claim 7, wherein said edge portions have a first part, which is inclined toward a wall to which said radiator is to be fixed, and a second end part, which is parallel to said front portion so as to form an acute edge angle for said radiator.

12. The radiator of claim 7, wherein said edge portions comprise a region which is bent in a shape of a circular arc.

13. The radiator of claim 7, wherein said edge portions comprise a first region which is perpendicular to said front portion.
